(19) United States
(12) Patent Application Publication
(10) Pub. No.: US 2026/0307910 A1
(43) Pub. Date: Oct. 8, 2026

(54) SINGULATOR BRUSHES

(71) Applicant: Transportation IP Holdings, LLC, Norwalk, CT (US)

(72) Inventors: Matthew John Orvedahl, Racine, WI (US); Ulisis Santiago, Norwalk, CT (US); Daniel Benjamin Hakes, Oak Creek, WI (US); Ozan Emsun, Milwaukee, WI (US)

(73) Assignee: Transportation IP Holdings, LLC, Norwalk, CT (US)

(21) Appl. No.: 19/169,246

(22) Filed: Apr. 3, 2025

(51) Int. Cl. B65G 19/02; B65G 47/256

(52) U.S. Cl. CPC B65G 19/02; B65G 47/256

(57) ABSTRACT

An object transport system includes a frame composed of a first and a second plate defining a chute therebetween and a conveyor disposed below the chute and having a protrusion that extends from the conveyor through the chute. The conveyor is configured to move the protrusion along a path defined by the chute. The system further includes a singulator disposed at a level relative to a top of the protrusion and fixedly positioned with respect to the chute. A method of using the system includes disposing a fastener within the chute, moving the fastener by the conveyor along the path defined by the chute, and removing the fastener from the chute by the singulator when the fastener is misaligned with respect to the chute. The method may also include removing the fastener from the chute by a first singulator and a second singulator.

### BACKGROUND

### Technical Field

The subject matter described herein relates to systems and methods for assuring alignment of a group of objects along a transport system.

### Discussion of Art

Automated transport systems may be used to transport objects from one location to another. An example of an automated transport system may be one that moves one object from a storage location to a destination location in which the objects may be processed further. The storage location, for example a bin, may hold a plurality of the objects, and the automated transport system may move the objects in single file to the destination location. The objects may be processed, one or a few at a time, at the destination location. In one aspect, additional automation may process the objects at the destination location. Successful processing of the objects at the destination location may be enhanced if the objects are aligned in a specified manner. Lack of proper alignment of the objects may reduce the effectiveness of the automated processing leading to potential equipment fouling or loss of the objects during processing.

In one example, the objects may be generally rectangular boxes. One or more plates or fins disposed along the automated transport system may be sufficient to align the objects for down-stream processing. In an alternative example, the objects may have a generally long and thin geometry. Further, the objects may have dissimilar vertical ends. The down-stream processing may preferentially use objects that are essentially vertically aligned along their longitudinal axes and have a specified end pointing in an upward direction. Manual placement of the objects in the correct alignment on the automated transport system may be slow and error prone. It may be desirable to have an automated system and method to assure proper alignment of such long and thin objects on the automated transport system that is different from existing mechanisms.

### SUMMARY

In one aspect, a system may include a frame composed of a first plate and a second plate defining a chute therebetween. The system may include a conveyor disposed below the chute in which the conveyor includes a protrusion that extends from the conveyor through the chute. The conveyor may be configured to move the protrusion along a path defined by the chute. The system may further include a singulator disposed at a level relative to a top of the protrusion and fixedly positioned with respect to the chute.

In one aspect, a method may include disposing a fastener within a chute defined by a first plate and a second plate disposed within a frame. The method may further include moving the fastener along a path defined by the chute by a conveyor disposed below the chute, in which the conveyor includes a protrusion that extends from the conveyor through the chute. The method may further include removing the fastener from the chute by a singulator disposed at a level relative to a top of the protrusion and fixedly positioned with respect to the chute when the fastener is misaligned with respect to the chute.

In another aspect, a method may include disposing a fastener within a chute defined by a first plate and a second plate disposed within a frame, and moving the fastener along a path defined by the chute by a conveyor disposed below the chute. The conveyor may also include a protrusion that extends from the conveyor through the chute. The method may further include removing the fastener from the chute by a first singulator and a second singulator. The first singulator and the second singulator may be disposed at a level relative to a top of the protrusion and fixedly positioned with respect to the chute. The fastener may be removed when the fastener is misaligned with respect to the chute.

### BRIEF DESCRIPTION OF THE DRAWINGS

The subject matter may be understood from reading the following description of non-limiting embodiments, with reference to the attached drawings, wherein below:

FIG. 1 is a perspective schematic of an automated transport system, according to one aspect of the disclosure;

FIG. 2 is an expanded portion of the perspective schematic of FIG. 1, according to one aspect of the disclosure;

FIG. 3A is a perspective view of a first example of singulator brushes depicted in FIG. 1, according to one aspect of the disclosure;

FIG. 3B is a perspective view a second example of singulator brushes depicted in FIG. 1, according to one aspect of the disclosure;

FIG. 4 is a perspective view of a third example of singulator brushes depicted in FIG. 1, according to one aspect of the disclosure;

FIG. 5 is a perspective view of a fourth example of singulator brushes depicted in FIG. 1, according to one aspect of the disclosure;

FIG. 6 is a perspective view of aligned fasteners and a misaligned fastener transported by the automated transport system through a pair of singulator brushes depicted in FIG. 3A, according to one aspect of the disclosure;

FIG. 7 is a perspective view of a second misaligned fastener transported by the automated transport system through a pair of singulator brushes depicted in FIG. 3A, according to one aspect of the disclosure;

FIG. 8 is a flow chart of a first method of removing a misaligned fastener from an automated transport system, according to one aspect of the disclosure; and

FIG. 9 is a flow chart of a second method of removing a misaligned fastener from an automated transport system, according to one aspect of the disclosure.

### DETAILED DESCRIPTION

Embodiments of the subject matter described herein relate to an automated transport system and method of transporting the supply of objects to equipment that processes the objects. The system may transport each of the objects from a storage location in a manner to align the objects in a desired orientation. For example, the automated transport system may consistently provide the objects in an alignment for use by down-stream processing automation. Various embodiments described herein may use the automated transport system to transport and align long and thin objects. In some examples, the long and thin objects may be fasteners. Although various examples described herein use fasteners as the objects, the automated transport system may be used to feed other types of long and thin objects to downstream automated devices. In some aspects, the fasteners may be metal fasteners for industrial applications. For example, the fasteners may be spikes (e.g., tie spikes), bolts (e.g., Lewis bolts), rivets, nails, and/or the like. The fasteners may be relatively heavy and move along a chute of the automated transport system. The automated transport system may be designed to accommodate and withstand the size, the weight, and the forces inherent with such industrial fasteners while providing reliable, consistent, and uniform alignment of the fasteners. The automated transport system described herein may provide a consistent alignment of single objects, such as fasteners, to increase the efficiency of automated operations that use the objects one at a time down-stream of the automated transport system. In one example, the fasteners may be delivered onto a vehicle route, where additional automated devices may use the fasteners to build or fabricate the route. In this example, a specialized rail vehicle may include a discharge device used to drive spikes into apertures or holes of plates disposed along the railroad track. The discharge device may be a hydraulic hammer. In one aspect, the automated transport system may also include the discharge device. The combination of the automated transport system and the discharge device may be mounted on a vehicle and may sequentially deliver the fasteners into the route at spaced apart locations along the length of the route.

In one or more aspects, the automated transport system may include a frame comprising a first plate and a second plate. A chute may be defined between the first and the second plate. A conveyor may be disposed below the chute. The conveyor may include one or more protrusions that may extend from the conveyor through the chute. The conveyor may be configured to move the protrusions along a path defined by the chute. A singulator may be disposed at a height relative to a top of the protrusion and in a fixed position with respect to the chute. Stated differently, the singulator may be fixed with respect to the frame and the chute and held at a height relative to the top of the protrusion, for example above or below the top of the protrusion.

In one or more aspects, the automated transport system may operate to dispose a fastener within a chute defined by a first plate and a second plate. The first plate and the second plate may be disposed within a frame. The automated transport system may operate a conveyor disposed below the chute to move the fastener along a path defined by the chute. The conveyor may move the fastener using a protrusion that extends from the conveyor through the chute. The automated transport system may further operate a singulator disposed at a level relative to a top of the protrusion. The singulator may be disposed at a fixed position with respect to the chute. Stated differently, the singulator may be fixed with respect to the frame and the chute and held at a height relative to the top of the protrusion, for example above or below the top of the protrusion The singulator may remove the fastener from the chute when the fastener is misaligned with respect to the chute.

In one or more aspects, the automated transport system may operate to dispose a fastener within a chute defined by a first plate and a second plate. The first plate and the second plate may be disposed within a frame. The automated transport system may operate a conveyor disposed below the chute to move the fastener along a path defined by the chute. The conveyor may move the fastener using a protrusion that extends from the conveyor through the chute. The automated transport system may further operate a first singulator and a second singulator. The first singulator and the second singulator may be disposed at a level relative to a top of the protrusion. The first singulator and the second singulator may be disposed at a fixed position with respect to the chute. Stated differently, the first and second singulators may be fixed with respect to the frame and the chute, and held at a height relative to the top of the protrusion, for example above or below the top of the protrusion. The first singulator and the second singulator may remove the fastener from the chute when the fastener is misaligned with respect to the chute.

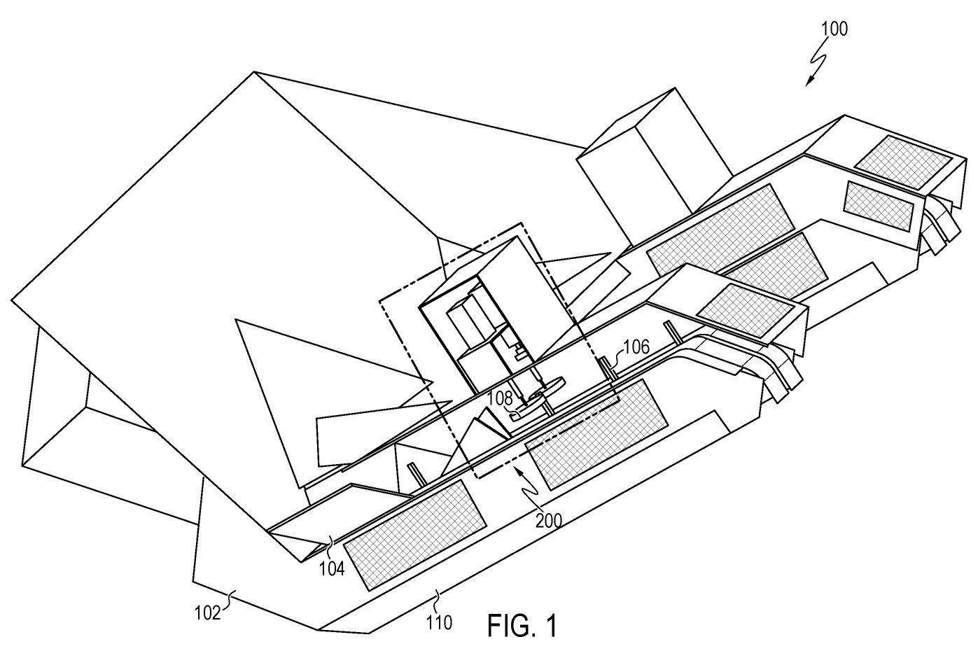

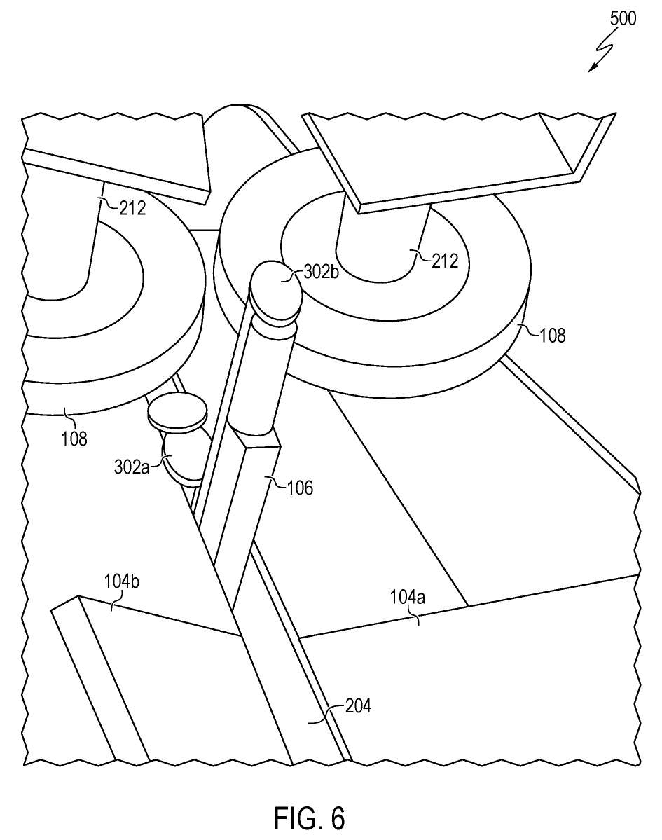

FIG. 1 is a perspective schematic of one aspect of an automated transport system 100. The automated transport system may include a source location – such as a bin 102 – for storing the objects to be transported. The automated transport system may include a frame 110 composed of multiple components suitable for storing and transporting the objects. The frame may include multiple plates 104 (also see plates 104a,b in FIGS. 6-8), in which the plates define a chute therebetween. A conveyor may be disposed below the chute. A motor system may drive the conveyor to move along a path defined by the chute. A control circuit may operate the motor system to drive the conveyor at a linear speed. The control circuit may allow an operator to control a rate of linear speed and/or a direction of motion of the conveyor. The conveyor may include one or more protrusions 106. The protrusions may extend from the conveyor through the chute. Thus, a motion of the conveyor will move the protrusions along a path defined by the chute. The protrusions may have any suitable shape to move the objects from the bin through the automated transport system. In one non-limiting example, the protrusions may be composed of tines to transport long and thin objections such as fasteners. The tines may have a length and/or width similar to the fasteners.

The automated transport system may also include one or more singulators 108. A singulator may be considered a device to align, or maintain alignment of, one or more objects moving through the automated transport system. In one aspect, the singulator may also serve to remove objects that are not aligned according to the requirements of the transport system or of down-stream processing systems. In one non-limiting example, the objects may be long thin objects, such as fasteners, that may be maintained in a vertical orientation having a specified end pointing upwards. In one non-limiting aspect, the one or more singulators may be composed of discs or cylinders made of a deformable material. Non-limiting examples of deformable materials may include rubber or plastic. Another example of deformable materials may include flexible bristles, made of pliable materials such as a cylindrical wire brush or cylindrical plastic brush. In one aspect, the singulator may be disposed at a level relative to a top of the protrusion and having a fixed positioned with respect to the chute

In one aspect, the automated transport system may be horizontally disposed on a base surface. Alternatively, as depicted in FIG. 1, the automated transport system may be disposed at an angle relative to a base surface. The automated transport system may be angled so that the bin holding the objects is closest to the base surface for easy loading, and the remainder of the automated transport system may be angled obliquely away from the base surface. This orientation may permit easy access to the bin for loading the objects. The bin may include an inlet to the chute. The objects may fall into the chute under gravity at the inlet, and the protrusions may then carry the objects as the conveyor operates. A distance between the conveyor and the chute may permit long and thin objects to fall vertically into the chute so that a longitudinal axis of the objects protrudes vertically through the chute. The protrusions may then guide the objects along the path of the conveyor.

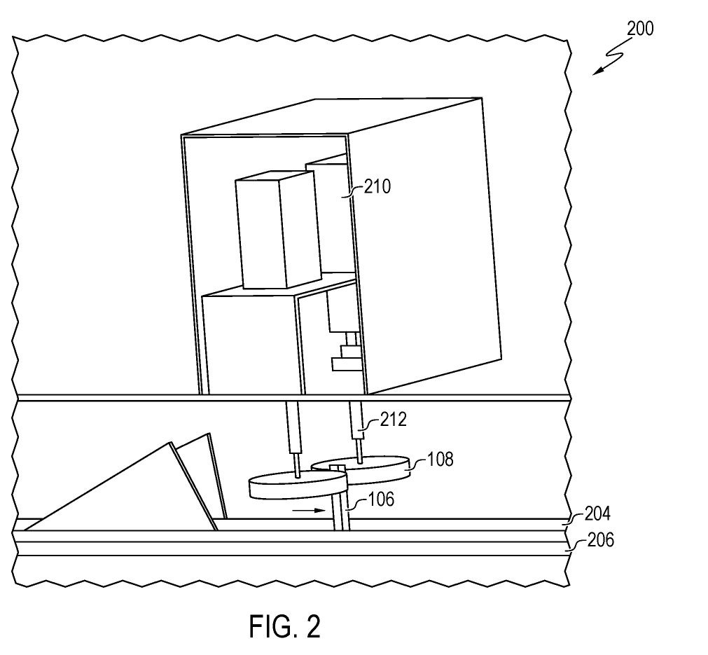

FIG. 2 depicts an expanded portion 200 of the automated transport system depicted in FIG. 1. In particular, the expanded portion highlights the chute 204 defined by the multiple plates, and the conveyor 206 disposed below the chute. FIG. 2 also depicts the protrusions that extend from the conveyor through the chute. Two singulators are depicted in FIG. 2, although a single singulator along with a knife may be used. The singulator or multiple singulators may be disposed at a level relative to the top of the protrusion and fixedly positioned with respect to the chute. In the aspect in which multiple singulators are used, each singulator may be disposed at the same level, but may be fixed at a position linearly offset from each other. Thus, a second singulator may be disposed at the level relative to the top of the protrusion and fixedly positioned with respect to the chute at an offset from the first singulator. In the example in which two singulators are used, the first singulator may be disposed at a first side of the chute and the second singulator may be disposed at an opposing side of the chute.

In one aspect, a singulator or multiple singulators (such as a second singulator) may be freely rotatable about its or their respective singulator axis or axes 212. Each freely rotatable singulator may rotate in response to an object contacting it as the object is transported by the conveyor. In the example of two singulators, the object may travel between the two singulators and may contact the two singulators either simultaneously or sequentially. In another example, a singulator may be coupled by the singulator axis to a motor 210. In one example, if multiple singulators are used, each singulator may be coupled by its own axis to a separate motor. Thus, the motors may operate independently. In an alterative example, a single motor may be coupled via a mechanical linkage to rotate multiple singulators synchronously. A motor system may drive the one or more singulators to rotate about the respect singulator axis or axes. A control circuit may operate the motor system to drive the singulators at a rotational speed. The control circuit may allow an operator to control a rate of rotational speed and/or a direction of rotation of the one or more singulators.

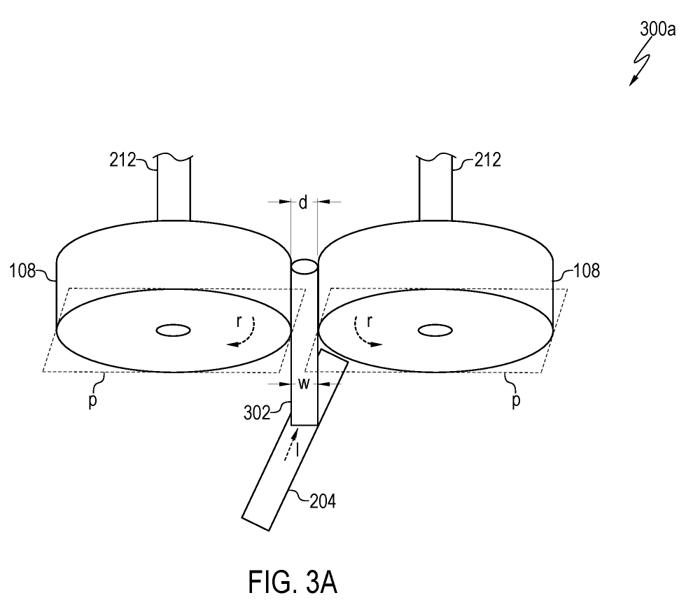

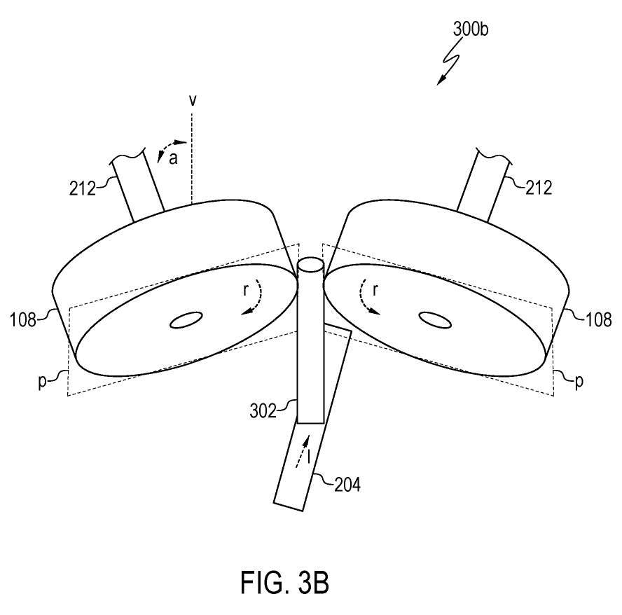

In one aspect, as illustrated in FIGS. 2 and 3A, the motor coupled to each of the first and the second singulator may be disposed above the direction of travel of the conveyor. FIG. 3A illustrates a first example 300a of an object 302 transported by the conveyor in a linear direction l having a linear speed. The motors attached to the axes of the singulators may rotate the singulators in a rotational direction r at a rotational speed. In one aspect, the rotational direction may be the same as the linear direction of the conveyor. Alternatively, the rotational direction may be opposite to the linear direction of the conveyor. Additionally, the rotational speed of each of the first and second singulator may be greater than the linear speed of the object transported by the conveyor. Alternatively, the rotational speed of each of the first and second singulator may be less than the linear speed of the object transported by the conveyor. A distance d may separate the sides of each of the two singulators. Further, the object may have a width w. In one example, the distance between the sides of the singulators may be less than the width of the object. Because the singulators are made of a deformable material, the object may pass between the sides of the two singulators by deforming the singulator shape as it passes. In this manner, the object may be forced into contact with the sides of the singulators, which may remove a misaligned object as discussed below.

As depicted in FIG. 3A, the singulator axes may be essentially vertically orthogonal with respect to a plane defined by the chute. An end of each singulator may define a plane p which may be parallel to a plane defined by the chute. In one aspect, a length of each singulator may be the same. In this aspect, the planes defined by the ends of the singulators may be co-planar. Alternatively, the singulators may have differing lengths or may have the ends of the singulators at differing heights. In this alternative aspect, the planes of the two singulators may be parallel to each other and to the plane defined by the chute but may not be co-planar.

FIG. 3B illustrates a second example 300b of the object transported by the conveyor in a linear direction. Reference characters in FIG. 3B refer to similar components as labeled in FIG. 3A. FIG. 3B illustrates that the axes of the singulators may be tilted from a vertical axis v by an angle a. In some non-limiting examples, the angle may range from about 0⁰ to about 45⁰ from vertical. In an alternative example, the angle may be greater than 45⁰ but less than 90⁰. In this configuration, the planes defined by the ends of the singulators may not be parallel to the plane defined by the chute. An object passing between the singulators may contact only a portion of the side of each singulator.

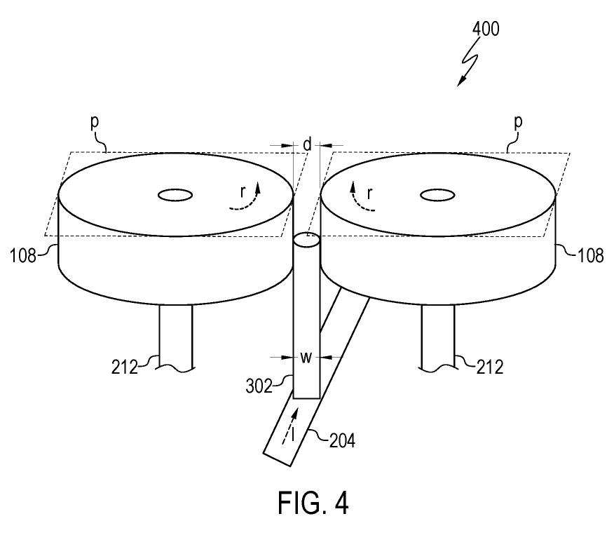

FIG. 4 illustrates a third example 400 of the object transported by the conveyor in a linear direction. Reference characters in FIG. 4 may refer to similar components as labeled in FIG. 3A. Similar to the example depicted in FIG. 3A, the motors attached to the axes of the singulators may rotate the singulators in a rotational direction r at a rotational speed. In one aspect, the rotational direction may be the same as the linear direction of the conveyor. Alternatively, the rotational direction may be opposite that of the linear direction of the conveyor. Additionally, the rotational speed of each of the first and second singulator may be greater than the linear speed of the object transported by the conveyor. Alternatively, the rotational speed of each of the first and second singulator may be less than the linear speed of the object transported by the conveyor. A distance d may separate the side of each of the two singulators. Further, the object may have a width w. In one example, the distance between the sides of the singulators may be less than the width of the object. Because the singulators are made of a deformable material, the object may pass between two singulators by deforming the singulator shape as it passes by. In this manner, the object may be forced into contact with the sides of the singulators, which may remove a misaligned object as discussed below. As in FIG. 3A, the third example depicted in FIG. 4 illustrates the singulator axes disposed essentially vertically orthogonal with respect to a plane defined by the chute. An end of each singulator may define a plane p which may be parallel to a plane defined by the chute. In one aspect, a length of each singulator may be the same. In this aspect, the planes defined by the ends of the singulators may be co-planar. Alternatively, the singulators may have differing lengths or may have the ends of the singulators at differing heights. In this alternative aspect, the planes of the two singulators may be parallel to each other and to the plane defined by the chute but may not be co-planar. In FIG. 4, however, the motors coupled to the axis of each of the first and the second singulator may be disposed below the direction of travel of the conveyor. Although not illustrated in FIG. 4, the axes of the singulators may also be tilted from a vertical axis by an angle, similar to example 300b in FIG. 3B. In some non-limiting examples, the angle may range from about 0⁰ to about 45⁰ from vertical. In an alternative example, the angle may be greater than 45⁰ but less than 90⁰. In this configuration, the planes defined by the ends of the singulators may not be parallel to the plane defined by the chute. An object passing between the singulators may contact only a portion of the side of each singulator.

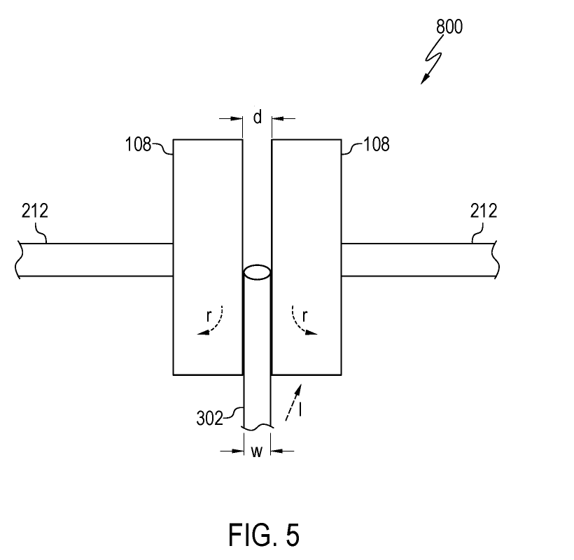

FIG. 5 illustrates a fourth example 800 of the object transported by the conveyor in a linear direction. Reference characters in FIG. 5 may refer to similar components as labeled in FIG. 3A. Similar to the example depicted in FIG. 3A, the motors attached to the axes of the singulators may rotate the singulators in a rotational direction r at a rotational speed. In one aspect, the rotational direction may be the same as the linear direction of travel l of the object. Alternatively, the rotational direction may be opposite to the linear direction of travel l of the object. Additionally, the rotational speed of each of the first and second singulator may be greater than the linear speed of the object transported by the conveyor. Alternatively, the rotational speed of each of the first and second singulator may be less than the linear speed of the object transported by the conveyor. As illustrated in FIG. 5, the axes of the singulators may be at a 90⁰ angle with respect to a vertical axis. Thus, the axes of the singulators may be horizontally disposed. As a result, the planes defined by the ends of the singulators may be parallel to each other but orthogonal to the plane defined by the chute. The object passing between the singulators may thus contact the ends of the singulator as opposed to the side of the singulators as illustrated in FIG. 3A. A distance d may separate the ends of each of the two singulators. Further, the object may have a width w. In one example, the distance between the ends of the singulators may be less than the width of the object. Because the singulators are made of a deformable material, the object may pass between two singulators by deforming the singulator shape as it passes by. In this manner, the object is forced into contact with the ends of the singulators, which may remove a misaligned object as discussed below.

Although the singulators illustrated in FIG. 3A – FIG. 5 are disclosed to operate in concert with one or more motors, each of the examples may also encompass the operation of a single, motorized singulator or one or more singulators that are freely rotatable about their respective axes and not driven by a motor.

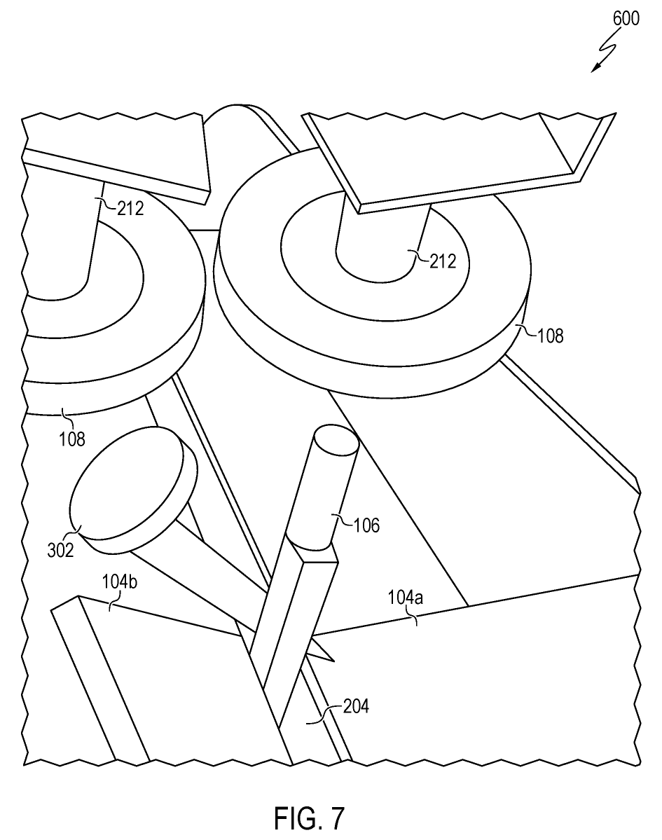

FIGS. 6-7 illustrate various operational modes of the transport system, and specifically regarding the effect of the singulators on objects transported by the protrusions along the chute. Example 500, depicted in FIG. 6, illustrates the passage of one or more objects 302a,b, conducted by a protrusion 106 through the chute 204 and towards the singulators 108. In this example, the object may be a long thin fastener having a first end (illustrated) that differs from a second end (not shown). The object may have a vertical axis that may be orthogonal to a plane defined by the chute. In this orientation, the object may be properly aligned according to the needs of down-stream processing. In the aligned orientation, the object may be transported through the chute so that only the first end of the object extends above the chute. Objects 302a depicted in FIG. 6 are properly aligned, as only their first ends are visible above the chute. The properly aligned objects may then pass between the singulators without being removed from the chute. FIG. 6 further depicts one example of a misaligned object 302b. The misaligned object depicted in FIG. 6 extends well above the chute and may be contacted by the singulators which may impart unequal rotational forces to the opposing sides of the object. As a result, the object may be removed from the chute.

FIG. 7 depicts example 600 of the passage of an object 302 conducted by a protrusion 106 through the chute and towards the singulators. In this example, the object may be a long thin fastener having one end (illustrated) that differs from a second end (not shown). The object may have a vertical axis that may be oblique to a plane defined by the chute. In this orientation, the object may not be properly aligned according to the needs of down-stream processing. The object may then be caught by the singulators which may impart unequal rotational forces to the opposing sides of the object. As a result, the object may be removed from the chute.

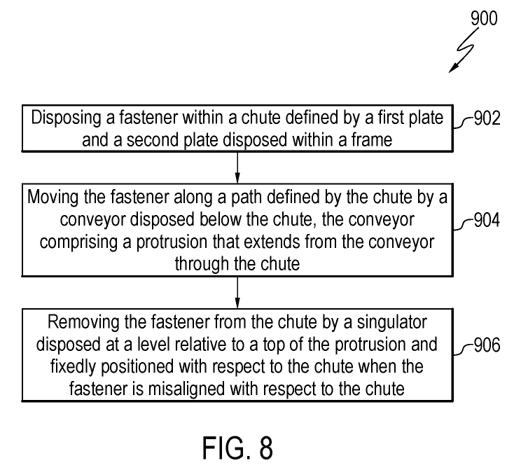

FIG. 8 illustrates a flow chart 900 depicting a method of removing a misaligned fastener from an automated transport system. In one aspect, the method may include disposing 902 a fastener within a chute defined by a first plate and a second plate disposed within a frame. The method may additionally include moving 904 the fastener along a path defined by the chute by a conveyor disposed below the chute, in which the conveyor includes a protrusion that extends from the conveyor through the chute. The method may further include removing 906 the fastener from the chute by a singulator disposed at a level relative to a top of the protrusion and fixedly positioned with respect to the chute when the fastener is misaligned with respect to the chute. The fastener may be considered misaligned with respect to the chute according to one or more non-limiting criteria. One criterion of misalignment may be that the fastener has a longitudinal axis that is not orthogonal to a direction of motion of the conveyor. Another criterion may be that the fastener has a bend along its longitudinal axis. Another criterion may be that multiple fasteners are bunched together. Yet another criterion may be that a preferred end of the fastener may not be accessible to the singulator (that is, a preferred end of the fastener may be pointing in an incorrect direction). In still another criterion, the fastener may not be engaged by the protrusion to move it by the conveyor. In another criterion, the fastener may not have descended sufficiently through the chute to engage a surface of the conveyor.

In an additional aspect, the method may include removing the fastener from the chute by the singulator when the fastener contacts the singulator.

The method may further include rotating the singulator in a direction of travel of the conveyor. In one example, the method may include rotating the singulator at a rotational speed greater than a linear rate of travel of the conveyor. The method may alternatively include rotating the singulator opposite to a direction of travel of the conveyor. In one alternative example, the method may include rotating the singulator at a rotational speed less than a linear rate of travel of the conveyor.

In another non-limiting aspect, the method may include engaging the fastener by the protrusion.

In another non-limiting aspect, the method may include moving the fastener along the path defined by the chute by moving the fastener along the path against gravity. In yet another non-limiting aspect, the method may further include returning a fastener removed by the singulator to a source of the fastener. As illustrated in FIG. 1, an automated transport system may be disposed at an angle relative to a base surface. The automated transport system may be angled so that the bin holding the objects is closest to the base surface for easy loading, and the remainder of the automated transport system may be angled obliquely away from the base surface. In this manner, the fasteners may be transported by the conveyor against gravity. A slide may be disposed below the chute. Fasteners removed by the singulators may drop onto the slide and passively role or slide down to the bin. In this manner, fasteners removed by the singulators may return to the bin for reloading onto the chute. Fasteners removed by the singulators thus may be reused, thereby saving the cost of manually reloading the fasteners into the bin or discarding the fasteners. In an alternative aspect, fasteners removed by the singulator may fall onto a second conveyor instead of onto a slide. The second conveyor may operate in a direction opposite to the first conveyor. The second conveyor may thus actively transport the rejected fasteners back to the bin.

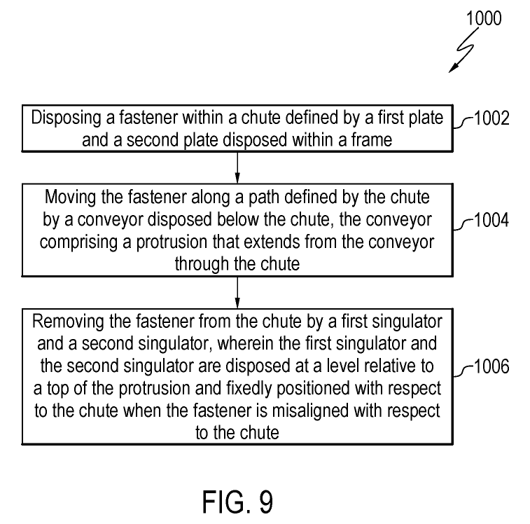

FIG. 9 illustrates a flow chart 1000 depicting another method of removing a misaligned fastener from an automated transport system. In one aspect, the method may include disposing 1002 a fastener within a chute defined by a first plate and a second plate disposed within a frame. The method may further include moving 1004 the fastener along a path defined by the chute by a conveyor disposed below the chute, in which the conveyor includes a protrusion that extends from the conveyor through the chute. The method may additionally include removing 1006 the fastener from the chute by a first singulator and a second singulator. The first singulator and the second singulator may be disposed at a level relative to a top of the protrusion and fixedly positioned with respect to the chute. The first singulator and the second singulator may remove a fastener that is misaligned with respect to the chute.

In one non-limiting aspect, the method may include rotating the first singulator and the second singulator in a direction of travel of the conveyor. A rotational speed of the first singulator and a rotational speed of the second singulator may both be greater than a linear rate of travel of the conveyor. In one alternative non-limiting aspect, the method may include rotating the first singulator and the second singulator opposite to a direction of travel of the conveyor. In another alternative aspect, a rotational speed of the first singulator and a rotational speed of the second singulator may both be less than a linear rate of travel of the conveyor.

The terms "control circuit" and “controller” are substitutable with each other and encompasses hardwired circuitry, programmable logic (such as microprocessors, microcontrollers, digital signal processors (DSPs), programmable logic devices (PLDs), programmable gate arrays (PGAs), or field-programmable gate arrays (FPGAs)), state machines, or firmware that executes stored instructions. Control circuits may form part of larger systems, such as integrated circuits (ICs), application-specific integrated circuits (ASICs), or systems-on-chips (SoCs), and may be found in devices such as computers, smartphones, wearable devices, and servers. These circuits may perform tasks involving data processing, communication, or data storage. Depicted components, functions, or operations may be implemented using hardware, software, firmware, or combinations of two or more thereof.

Instructions for implementing system features can be stored in various types of memory. Suitable memory may include dynamic random-access memory (DRAM), flash memory, and/or cache. These instructions can be distributed over a network or via other computer-readable media. The term "non-transitory computer-readable medium" refers to any physical medium capable of storing or transmitting instructions or information that can be read by a machine. Examples of suitable media include RAM, ROM, EPROM, EEPROM, magnetic or optical media, flash memory, or even propagated signals such as carrier waves or infrared signals.

In some embodiments, the control circuit can utilize machine learning (ML) techniques to make decisions based on sensor inputs or other data. Suitable ML methods may include supervised learning (with labeled inputs and outputs), unsupervised learning (for identifying patterns), or reinforcement learning (where the system adapts based on feedback). Suitable tasks for ML systems may involve classification, regression, clustering, anomaly detection, or optimization. ML may employ algorithms, such as decision trees, deep learning, support vector machines (SVMs), or neural networks, depending on the application. A suitable control circuit may incorporate a policy engine that applies specific rules based on equipment characteristics or environmental conditions. For instance, a neural network could process sensor data or operational inputs to determine appropriate actions. Techniques such as backpropagation or evolutionary strategies may be used to refine neural network parameters and optimize model selection for the given task.

In one embodiment, the control circuit (or controller) and system described herein may use machine learning to make determinations and to enable derivation-based learning outcomes. The system may communicate with a data collection system. The control circuit may learn from, model and make decisions/determinations on a set of data (including data provided by various sensors and data collection systems) by making data-driven predictions and adapting according to available data and modeling. Machine learning may involve performing tasks using supervised learning, unsupervised learning, and reinforcement learning systems. Supervised learning may use a set of example inputs and desired outputs to the machine learning systems, where unsupervised learning may use a learning algorithm that is structuring its input with, e.g., pattern detection and/or feature learning. Reinforcement learning may perform in a dynamic environment and then provide feedback about correct and incorrect decisions. Machine learning may include tasks based on certain outputs. These tasks may be machine learning problems such as classification, regression, clustering, density estimation, dimensionality reduction, anomaly detection, and the like to include other mathematical and statistical techniques. Suitable machine learning algorithmic types may include decision tree based learning, association rule learning, deep learning, artificial neural networks, genetic learning algorithms, inductive logic programming, support vector machines (SVMs), Bayesian network, reinforcement learning, representation learning, rule-based machine learning, sparse dictionary learning, similarity and metric learning, learning classifier systems (LCS), logistic regression, random forest, K-Means, gradient boost, K-nearest neighbors (KNN), a priori algorithms, and the like. In embodiments, certain machine learning algorithms may be used (e.g., for solving both constrained and unconstrained optimization problems that may be based on natural selection). In an example, the algorithm may be used to address problems of mixed integer programming, where some components restricted to being integer-valued. Algorithms and machine learning techniques and systems may be used in computational intelligence systems, computer vision, Natural Language Processing (NLP), recommender systems, reinforcement learning, building graphical models, and the like. In an example, machine learning may be used for making determinations, calculations, comparisons and behavior analytics, and the like.

As mentioned above, the control circuit may include a policy engine. The policies the engine may apply can be based at least in part on characteristics of a given item of equipment or environment. For example, an artificial intelligence system, such as a neural network, can receive input of a number of environmental and task-related parameters. These parameters may include, for example, operational input of the given equipment, data from various sensors, environmental information, location and/or position data, and the like. The neural network can be trained and can generate an output based on these inputs, with the output representing an action or sequence of actions that the equipment or system should take to accomplish the goal of the operation. The control circuit can process the inputs through the parameters of the neural network to generate a value (i.e., make a determination) at the output node designating that action as the desired action, activity, or operating state. An action may translate into a signal that causes the vehicle to operate in a particular manner. The control circuit may accomplish this via back-propagation, feed forward processes, closed loop feedback, or open loop feedback, for example. Alternatively, rather than using backpropagation, the control circuit may use evolution strategies techniques to tune various parameters of the neural network. The control circuit may use neural network architectures that have a set of parameters representing weights of its node connections. A number of copies of this network can be generated and adjustments to the parameters can be made with subsequent simulations. Once the outputs from the various models have been obtained, they may be evaluated on their performance using a determined success metric. The best model or a good-enough model may be selected, and the control circuit can execute that plan to achieve the desired input data to mirror the predicted ‘best outcome’ scenario. Additionally, the success metric itself may be a combination of the optimized outcomes, which may be weighed relative to each other. Success metrics may be dynamically established, and the process rerun and the equipment directions further modified.

In one embodiment, data can be generated, transmitted, and stored and may involve one or both of a protected space data source and the exposed space data source. The control circuit may encrypt and decrypt data as needed at rest, during use, or in transit. Encryption keys and schema may be selected and implemented as informed by end use parameters and requirements. The control circuit may evaluate and/or identify a decision boundary (that is, a boundary that separates desired behavior from undesired behavior) with regard to that data. If the control circuit determines that some quantity of data is from a protected space data source and/or is operating within determined boundaries then the control circuit, and the equipment being controlled, may operate normally. However, if the data is determined to be from an exposed space data source and/or it crosses the decision boundary, the control circuit may respond. Suitable responses may be to power down determined equipment, signal an alert, run a diagnostic routine, perform a data backup (without overwriting existing backup data), isolate equipment (including by suspending some or all communication pathways), switch equipment or control operations to a safe mode of the control system, and/or initiate a safe mode state of the equipment (e.g., slow a vehicle to a safe and controlled stop). The safe mode may be, in one embodiment, a soft shutdown mode that it intended to avoid damage or injury based on the shutdown itself and in another embodiment may be a reboot and/or minimal reload of essential drivers and functionality.

In one embodiment, vehicle systems may implement secure authentication processes, encryption protocols, and firewalls to protect against unauthorized access or spoofing. A suitable control circuit may include a security module responsible for detecting and responding to suspicious activities, such as unapproved data access attempts or irregular communication patterns. This module may employ machine learning to adapt its defense strategies, learning from previous attacks and adjusting security measures as needed to prevent similar breaches.

In certain embodiments, maintenance and diagnostic functions may be integrated into the control circuit, enabling the system to self-monitor for operational health. The control circuit may utilize diagnostic algorithms to assess the status of various vehicle components, such as engines, brakes, batteries, fuel cells and fuel systems, propulsion systems, and electronic systems (if present). If a component is found to be underperforming or at risk of failure, the control circuit may schedule alerts, recommend maintenance, or initiate safety protocols to avoid catastrophic failure. Self-diagnostics may use historical performance data to identify trends, facilitating proactive rather than reactive maintenance.

Terms such as "processing," "computing," "calculating," or "determining" refer to operations carried out by the control circuit, which may include computing systems or electronic devices that manipulate data represented as physical (electronic) quantities within memory or registers. One or more components may be described as "configured to," "configurable to," "operable/operative to," "adapted/adaptable to," or similar terms. Unless explicitly stated, these terms encompass components in both active and inactive states. Unless stated otherwise, terms like "including" or "having" should be interpreted as open-ended (i.e., "including but not limited to"). Numeric claim recitations generally mean "at least" the stated number, and disjunctive terms like "A or B" should be interpreted to include either or both unless explicitly specified. Operations in any claim may generally be performed in any order unless explicitly stated. The recitation "at least one of A, B, and C" should be interpreted as any combination of A, B, and C, such A alone, B alone, C alone, A and B together, A and C together, B and C together, and/or A, B, and C together. The recitation "at least one of A, B, or C" should be interpreted to include A alone, B alone, C alone, A and B together, A and C together, B and C together, and/or A, B, and C together.

This written description may disclose several embodiments of the subject matter, including the best mode, and may enable one of ordinary skill in the relevant art to practice the embodiments of subject matter, including making and using any devices or systems and performing any incorporated methods. The patentable scope of the subject matter is defined by the claims, and may include other embodiments that may occur to one of ordinary skill in the art. Such other embodiments may be intended to be within the scope of the claims if they may have structural elements that may not differ from the literal language of the claims, or if they may include equivalent structural elements with insubstantial differences from the literal languages of the claims.

What is claimed is:

1. A system comprising:
a frame comprising a first plate and a second plate defining a chute therebetween;
a conveyor disposed below the chute and comprising a protrusion that extends from the conveyor through the chute, wherein the conveyor is configured to move the protrusion along a path defined by the chute; and
a singulator disposed at a level relative to a top of the protrusion and fixedly positioned with respect to the chute.

2. The system of claim 1, wherein the singulator is freely rotatable about a first singulator axis.

3. The system of claim 1, wherein the singulator is a first singulator, and further comprising a first motor configured to rotate the first singulator about a first singulator axis.

4. The system of claim 3, wherein the conveyor is configured to move in a first direction, and the first motor is configured to rotate the first singulator in the first direction.

5. The system of claim 4, wherein the first motor is configured to rotate the first singulator at a rotational speed greater than a linear speed of the conveyor.

6. The system of claim 3, further comprising a second singulator disposed at the level relative to the top of the protrusion and fixedly positioned with respect to the chute at an offset from the first singulator.

7. The system of claim 6, wherein the first singulator is disposed at a first side of the chute and the second singulator is disposed at an opposing side of the chute.

8. The system of claim 6, wherein the second singulator is freely rotatable about a second singulator axis.

9. The system of claim 6, further comprising a second motor configured to rotate the second singulator about a second singulator axis.

10. The system of claim 9, wherein the second motor is configured to rotate the second singulator in a first direction at a rotational speed greater than a linear speed of the conveyor.

11. The system of claim 1, wherein the singulator is a cylindrical wire brush.

12. A method comprising:
disposing a fastener within a chute defined by a first plate and a second plate disposed within a frame;
moving the fastener along a path defined by the chute by a conveyor disposed below the chute, the conveyor comprising a protrusion that extends from the conveyor through the chute; and
removing the fastener from the chute by a singulator disposed at a level relative to a top of the protrusion and fixedly positioned with respect to the chute when the fastener is misaligned with respect to the chute.

13. The method of claim 12, further comprising removing the fastener from the chute by the singulator when the fastener contacts the singulator.

14. The method of claim 12, further comprising rotating the singulator in a direction of travel of the conveyor.

15. The method of claim 14, further comprising rotating the singulator at a rotational speed greater than a linear rate of travel of the conveyor.

16. The method of claim 12, further comprising engaging the fastener by the protrusion.

17. The method of claim 16, wherein moving the fastener along the path defined by the chute comprises moving the fastener along the path against gravity.

18. The method of claim 12, further comprising returning a fastener removed by the singulator to a source of the fastener.

19. A method comprising:
disposing a fastener within a chute defined by a first plate and a second plate disposed within a frame;
moving the fastener along a path defined by the chute by a conveyor disposed below the chute, the conveyor comprising a protrusion that extends from the conveyor through the chute; and
removing the fastener from the chute by a first singulator and a second singulator, wherein the first singulator and the second singulator are disposed at a level relative to a top of the protrusion and fixedly positioned with respect to the chute when the fastener is misaligned with respect to the chute.

20. The method of claim 19, further comprising:
rotating the first singulator and the second singulator in a direction of travel of the conveyor, wherein a rotational speed of the first singulator and a rotational speed of the second singulator are both greater than a linear rate of travel of the conveyor.
